(19) United States
(12) Patent Application Publication
(10) Pub. No.: US 2026/0023670 A1
(43) Pub. Date: Jan. 22, 2026

(54) TECHNIQUES FOR REDUCTION OF STORAGE EVENTS IN A CLOUD COMPUTING ENVIRONMENT

(71) Applicant: Wiz, Inc., New York, NY (US)

(72) Inventors: Yehonatan AMNON HORNSTEIN, Tel Aviv (IL); Itay HAREL, Tel Aviv (IL)

(73) Assignee: Wiz, Inc., New York, NY (US)

(21) Appl. No.: 18/944,939

(22) Filed: Nov. 12, 2024

Related U.S. Application Data
(63) Continuation-in-part of application No. 18/779,911, filed on Jul. 22, 2024.

(51) Int. Cl. G06F 11/30

(52) U.S. Cl. CPC G06F 11/3082; G06F 11/3075

(57) ABSTRACT

A method for generating and storing an aggregated data log is presented. The method includes: accessing a plurality of data log records in a repository; detecting a plurality of records in the repository, wherein each record includes a plurality of data fields; detecting a first data log record of the plurality of data log records having a first data field value in common with a second data log record; detecting in the first data log record a second data field having a second value; detecting in the second data log record the second data field having a third value; generating a merged data record based on: the first data field value, the second value and the third value; generating an aggregated data log based on the merged data record, wherein the aggregated data log includes a plurality of merged data records; and storing the aggregated data log in a repository.

### CROSS-REFERENCE TO RELATED APPLICATION

This application is a continuation in part of U.S. patent application Ser. No. 18/779,911, filed Jul. 22, 2024, the contents of which are hereby incorporated by reference.

### TECHNICAL FIELD

The present disclosure generally relates to the monitoring of computer networks, and specifically to monitoring data log streams of a virtual private cloud.

### BACKGROUND

A cloud computing event log is a comprehensive record of activities and operations within a cloud environment, capturing details like user logins, API requests, system errors, and configuration changes. Each entry is timestamped, providing precise timing for every event. These logs are essential for monitoring, troubleshooting, and auditing purposes, offering insights into the system's behavior and security.

However, the extensive nature of these logs can present significant challenges, especially as they grow large over time. The sheer volume of data can make it difficult to store, manage, and analyze logs efficiently. Large logs require substantial storage resources and can slow down the retrieval and processing of relevant information. Moreover, identifying significant events amid a vast amount of routine activity can be like finding a needle in a haystack, complicating efforts to detect anomalies or troubleshoot issues quickly. Effective log management strategies and tools are therefore crucial to handle the scale, ensuring that valuable insights can be extracted without being overwhelmed by the sheer quantity of data.

### SUMMARY

A summary of several key example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include accessing a plurality of data log records in a data log repository. The method may also include detecting a plurality of data log records in the data log repository, where each data log record includes a plurality of data fields; detecting a first data log record of the plurality of data log records having a first data field value in common with a second data log record; detecting in the first data log record a second data field having a second value; detecting in the second data log record the second data field having a third value; generating a merged data record based on: the first data field value, the second value and the third value; generating an aggregated data log based on the merged data record, where the aggregated data log includes a plurality of merged data records. The method may furthermore include storing the aggregated data log in an aggregated data log repository. Other embodiments of this aspect include corresponding computer systems, apparatus, and computer programs recorded on one or more computer storage devices, each configured to perform the actions of the methods.

Implementations may include one or more of the following features. The method may include: matching a data record value of the first data log record to a corresponding data record value of another data log record to detect a common data field value. The method may include: generating a merged data record in response to detecting at least one common data record value between a plurality of data log records from the data log repository. The method may include: generating an aggregated data log that includes common data record values from the merged data records. The method where the first data field includes any one of: an account identifier, a host header, a date, an authorization string, and any combination thereof. The method may include: detecting a data log record that is based on any one of: a data record, an event, a message, a request, an action in a virtual private cloud environment, and any combination thereof. The method may include: generating the aggregated data log based on a plurality of merged data records, where a first merged data record is generated from a first data log and a second merged data record is generated from a second data log. The method may include: determining that a first data field value is common in response to detecting at least a partial match between a value of the first data log record and a value of the second data log record. The method may include: filtering out a portion of records of the plurality of data records based on a value of a data field; and generating the aggregated data log based on the merged data record without the filtered portion of records. Implementations of the described techniques may include hardware, a method or process, or a computer tangible medium.

In one general aspect, non-transitory computer-readable medium may include one or more instructions that, when executed by one or more processors of a device, cause the device to: access a plurality of data log records in a data log repository. Medium may furthermore detect a plurality of data log records in the data log repository, where each data log record includes a plurality of data fields detect a first data log record of the plurality of data log records having a first data field value in common with a second data log record detect in the first data log record a second data field having a second value detect in the second data log record the second data field having a third value generate a merged data record based on. Medium may in addition include the first data field value, the second value and the third value generate an aggregated data log based on the merged data record, where the aggregated data log includes a plurality of merged data records. Medium may moreover store the aggregated data log in an aggregated data log repository. Other embodiments of this aspect include corresponding computer systems, apparatus, and computer programs recorded on one or more computer storage devices, each configured to perform the actions of the methods.

In one general aspect, a system may include one or more processors configured to. The system may also include access a plurality of data log records in a data log repository. The system may furthermore detect a plurality of data log records in the data log repository, where each data log record includes a plurality of data fields. The system may in addition detect a first data log record of the plurality of data log records having a first data field value in common with a second data log record. The system may moreover detect in the first data log record a second data field having a second value. The system may also detect in the second data log record the second data field having a third value. The system may furthermore generate a merged data record based on: the first data field value, the second value and the third value. The system may in addition generate an aggregated data log based on the merged data record, where the aggregated data log includes a plurality of merged records. The system may moreover store the aggregated data log in an aggregated data log repository. Other embodiments of this aspect include corresponding computer systems, apparatus, and computer programs recorded on one or more computer storage devices, each configured to perform the actions of the methods.

Implementations may include one or more of the following features. The system where the one or more processors are further configured to: match a data record value of the first data log record to a corresponding data record value of another data log record to detect a common data field value. The system where the one or more processors are further configured to: generate a merged data record in response to detecting at least one common data record value between a plurality of data log records from the data log repository. The system where the one or more processors are further configured to: generate an aggregated data log that includes common data record values from the merged data records. The system where the first data field includes any one of: an account identifier, a host header, a date, an authorization string, and any combination thereof. The system where the one or more processors are further configured to: detect a data log record that is based on any one of: a data record, an event, a message, a request, an action in a virtual private cloud environment, and any combination thereof. The system where the one or more processors are further configured to: generate the aggregated data log based on a plurality of merged data records, where a first merged data record is generated from a first data log and a second merged data record is generated from a second data log. The system where the one or more processors are further configured to: determine that a first data field value is common in response to detecting at least a partial match between a value of the first data log record and a value of the second data log record. The system where the one or more processors are further configured to: filter out a portion of records of the plurality of data records based on a value of a data field; and generate the aggregated data log based on the merged data record without the filtered portion of records. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a cloud computing environment including a data log aggregator, implemented in accordance with an embodiment.

FIG. 2 is an example identifiers diagram of a generated data log, implemented in accordance with an embodiment.

FIG. 3 is an example identifiers diagram of an aggregated data log generated by the data log aggregator, implemented in accordance with an embodiment.

FIG. 4 is an example flowchart of a method for generating and storing an aggregated data log, implemented in accordance with an embodiment.

FIG. 5 is an example schematic diagram of a data log aggregator, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

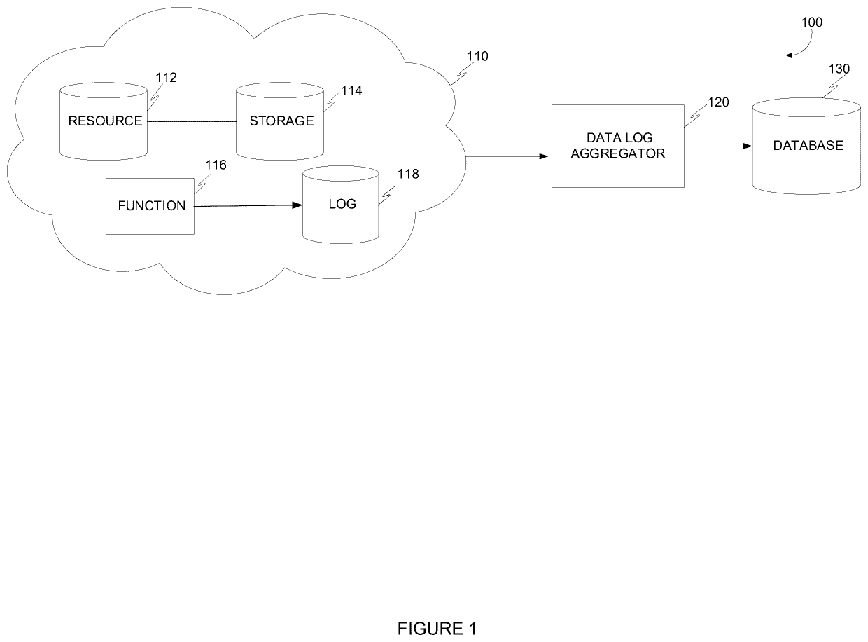

FIG. 1 is an example schematic diagram 100 of a data log aggregator 120 in a cloud computing environment 110, implemented in accordance with an embodiment. In an embodiment, the cloud computing environment 110 includes a resource 112, a storage 114, a serverless function 116, and a log 118. In an embodiment, a data log aggregator 120 is configured to access the log 118, and a database 130.

In an embodiment, a cloud computing environment 110 is implemented as a virtual private cloud (VPC), Virtual Network (VNet), virtual private network (VPN) and the like. A cloud computing platform is implemented on a cloud computing infrastructure, for example, such as Amazon® Web Services (AWS), Google Cloud Platform® (GCP), Microsoft® Azure, and the like.

In an embodiment, a cloud computing environment 110 includes cloud entities deployed therein. According to an embodiment, a cloud entity is, for example, a principal, a resource 112, a storage 114, a combination thereof, and the like. In an embodiment, a resource 112 and a storage 114, are cloud entities that provide access to a compute resource, such as a processor, a memory, storage, and the like.

In some embodiments, a resource 112 is a virtual machine, a software container, a serverless function, and the like. According to certain embodiments, a resource 112 includes a software application deployed thereon, such as a webserver, a gateway, a load balancer, a web application firewall (WAF), an appliance, various combinations thereof, and the like.

In an embodiment, a cloud entity is a principal relative to another cloud entity and a resource 112 to other cloud entities. In another embodiment, a cloud entity is a principal relative to another cloud entity. For example, a load balancer is a resource 112 to a user account requesting a webpage from a webserver behind the load balancer, and the load balancer is a principal to the webserver. In some embodiments, a resource 112 and a storage 114 are configured to communicate with each other via an internal bus, data bus, Local Area Network (LAN), inter-process communication (IPC), Application Programming Interfaces (APIs), and the like.

In certain embodiments, the function 116 is a serverless function which is configured to monitor events (e.g. messages, requests etc.) in a cloud computing environment 110 such as AWS, Amazon® Simple Queue Service (SQS), etc., a combination thereof and the like. In an embodiment, the function 116 is configured to read and organize the events based on specific dates and time instances. In certain embodiments, the function 116 is an Amazon Lambda serverless function which is configured to write the events to an Amazon® CloudTrail.

In an embodiment, the function 116 is configured to write the events to a storage and generate an event history. In various embodiments, the function 116 is configured to generate and extract metadata from the events. In an embodiment, the function 116 is configured to generate data log records based on the extracted metadata from the events.

In certain embodiments, the data log records include data record values which identify any one of: user account identifiers, host headers, dates, timestamps, authorization strings, a combination thereof, and the like.

In an embodiment, the function 116 is configured to write events to a log 118, stored for example using a bucket, which is configured to store the generated data log records from the function 116. In some embodiments, the log 118 includes a software tool, a software application, and the like, for collecting, parsing, manipulating, storing, etc., the generated data log records.

In certain embodiments, data log records contain data such as account identifiers, host headers, timestamps, dates, bucket names, authorization data, a combination thereof and the like. In certain embodiments, the log 118 is an Amazon® Simple Storage Service (Amazon® S3) bucket, or any other object storage device or service. In an embodiment, a data log record is generated based on a predetermined data schema.

In various embodiments, a data log aggregator 120 is configured to access the log 118 to read the generated data log records in the data log repository stored in the log 118. In an embodiment, the data log aggregator 120 is configured to access the data log records in the data log repository of the log 118. In some embodiments, the data log aggregator 120 is configured to detect data log records from the data log repository that can be merged, for example based on a predefined heuristic.

In an embodiment, each data log record contains data record values. In some embodiments, each data log record includes data record values which identify any one of: an account identifier, a host header, a bucket, a date (e.g. timestamp, etc.), an authorization string, a combination thereof, and the like. In an embodiment, the data log aggregator 120 is configured to generate a merged data log record in response to detecting multiple data log records having at least one common data record value.

For example, in an embodiment, a common data record value is detected where a data record value of a first data log record matches a corresponding data record value of another data log record. For example, in an embodiment, the data log aggregator 120 is configured to detect a first data log record and a second data log record which share any one of the same: user account identifier, host header, a combination thereof, and the like. In some embodiments, the data log aggregator 120 is configured to generate a merged data record based on the detected matching data record values. In various embodiments, the data log aggregator 120 will generate an aggregated data log based on the merged data records.

For example, in an embodiment, the data log aggregator 120 is configured to store a single merged data record value for the user account identifier, host header, a combination thereof, and the like, based on the common data record values of the first data log and second data log. For example, in an embodiment, where the host header is “bucket.s3.<us-east>.amazonaws.com”, for multiple records, the single merged data record value is “bucket.s3.<us-east>.amazonaws.com”.

In certain embodiments, where there are different data record values for corresponding data fields of the first data log record and the second data log record, the data log aggregator 120 is configured to generate an aggregated data record value. For example, in an embodiment, where the date is “Thursday, Aug. 24, 2023”’ in a first data log record, and “Friday, Dec. 10, 2023” in a second data log record, the merged data record includes: the first value (e.g. Thursday, Aug. 24, 2023), the second value (e.g. Friday, Dec. 10, 2023), or a combination thereof. In an embodiment, for example, an aggregate data value is generated from different data record values and stored as an array containing each different data record value from each one of the data log records.

Therefore, the data log aggregator 120 reduces the vast amount of data log records and data stored in a database as well as storage cost by generating merged data records and storing only the merged data records in a database. In another embodiment, the data log aggregator 120 enriches the aggregated records with additional metadata such as to information about the detected events, messages, commands, a combination thereof and the like.

In an embodiment, the database 130 (e.g. data log repository) is configured to store the aggregated data records generated from the data log aggregator 120. A database 130 is a collection of data that is organized, accessed, and stored in a computer system. In an embodiment, the database 130 is managed through a database management system (DBMS), which is a software used to manage the data.

In another embodiment, the database 130 is a cloud database which is deployed to run in a public or hybrid cloud environment and is managed by database-as-a-service (DBaaS) or deployed in a cloud-based virtual machine (VM). In certain embodiments, the database 130 is implemented using a Snowflake® platform, data lake, data warehouse, and the like, which is designed for cloud environments and leverages the storage and computing power of cloud infrastructure, and furthermore utilizes a unique structured query language (SQL) query engine.

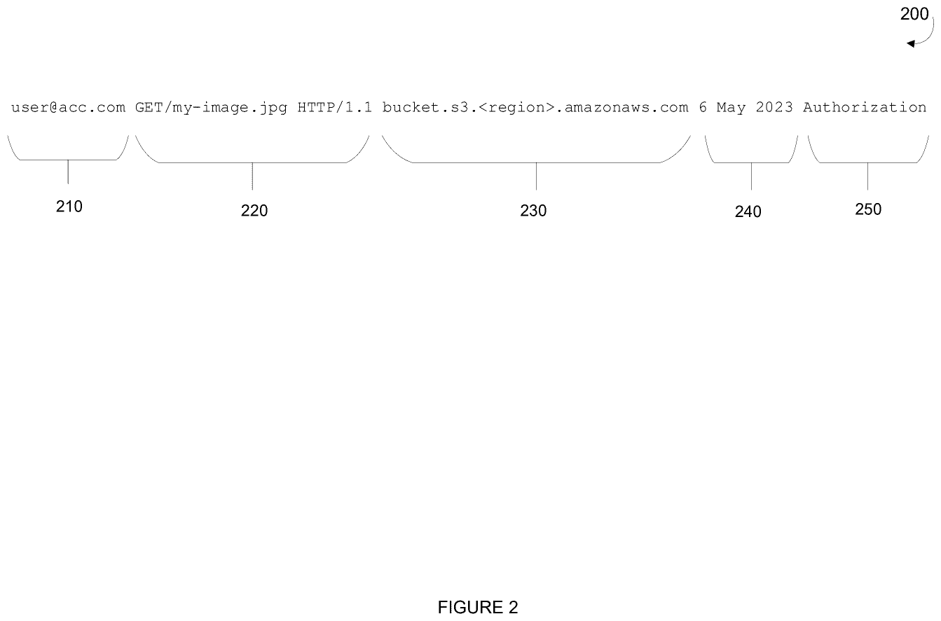

FIG. 2 is an example diagram of a data record of a data log 200, utilized to describe an embodiment. In various embodiments, the function 116 of FIG. 1 is configured to generate data logs based on collecting data packets which contain data related to detected events, messages, from communication traffic going to and from network interfaces in a clod computing environment, such as a VPC.

In an embodiment, a packet analyzer (e.g. sniffer) is configured to read the data packets, and extract metadata values (e.g. payload, size, timestamp, etc.) from the data packets. In other embodiments, the function 116 is configured to utilize these metadata values extracted from the packets to generate the data log based on a predefined schema.

In an embodiment, an example generated data log record includes a user account identifier 210, a request 220, a host header 230, a date 240, an authorization 250, a combination thereof, and the like. In various embodiments, a user account identifier 210 identifies the user of the account who is making the network request. In an embodiment, the user account identifier 210 includes a user account identification name and a domain name. In some embodiments, a request 220 includes an operational function, a full key name of an object, a combination thereof, and the like. For example, in an embodiment, a request 220 includes a “GetObject” function that is used to retrieve fundamental entities stored in a storage device, such as Amazon® S3.

In an embodiment, the term “my-image.jpg” of the request 220 represents the object name of an entity stored in a storage device. In an embodiment, objects consist of metadata. In an embodiment, the metadata is a set of name-value pairs that describe the object. These pairs include some default metadata, such as last date modified and standard HTTP metadata. In an embodiment, you can specify custom metadata at the time that the object is stored.

In some embodiments, the request 220 includes “HTTP/1.1.” which indicates the type of version protocol that must be used to retrieve the object.

In some embodiments, the host header 230 includes a bucket name, a region code, and a host site, a combination thereof, and the like. In an embodiment, the bucket name is “bucket.s3.” in 230. In some embodiments, the region code includes the country, region, state, etc. a combination thereof, and the like. In an embodiment, the host header 230 includes the host site, such as “amazonaws.com”.

In various embodiments, the data log 200 includes a date 240 of which the request 220 was generated. In an embodiment, the date 240 of the request 220 includes the month, year, date, weekday, a combination thereof, and the like. Further, in an embodiment, the date 240 includes a timestamp which indicates the time the request 220 was initiated and includes the hour, minutes, seconds, time zone, a combination thereof, and the like.

In various embodiments, the data log 200 includes an authorization string 250 that provides permission to access individual buckets and objects.

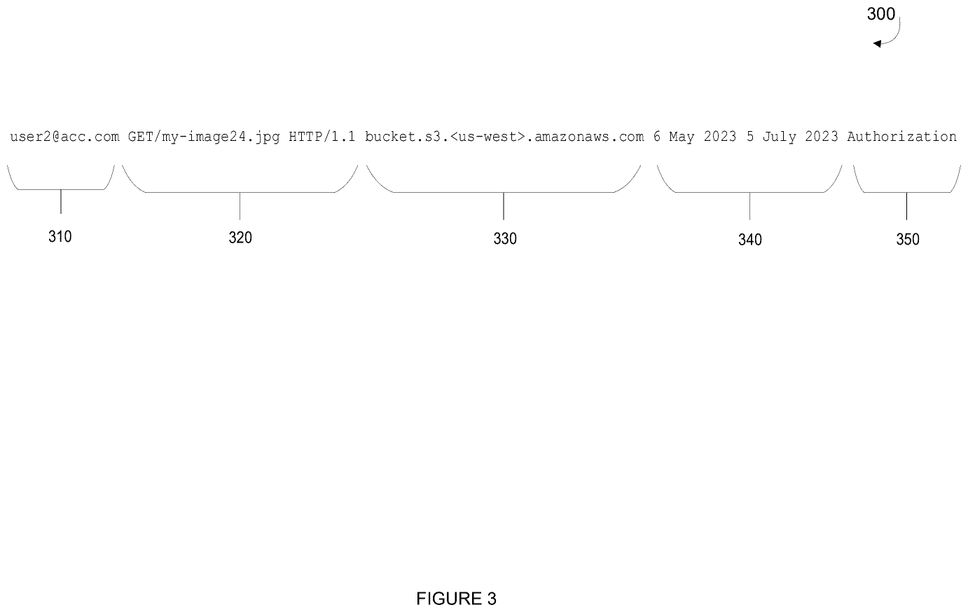

FIG. 3 is an example merged data record 300 of an aggregated data log generated by a data log aggregator, implemented in accordance with an embodiment. In an embodiment, the data log aggregator (FIG. 1, 120) is configured to generate aggregated data log records based on merged records from detected data log records in the log 118 repository. In some embodiments, the data log aggregator (FIG. 1, 120) is configured to access data log records in the log 118 repository and detect data log records that can be merged. For example, a first data log record and a second data log record can be merged to generate a merged log record based on a heuristic.

In an embodiment, the data log aggregator (FIG. 1, 120) is configured to determine that the data log records should be merged in response to detecting common data record values between multiple data log records. In certain embodiments, the data log aggregator (FIG. 1, 120) is configured to generate a merged record for detected data logs with common data record values. In an embodiment, the data log aggregator (FIG. 1, 120) is configured to generate an aggregated data log based on the merged records that include the common data record values.

In an embodiment, an example aggregated data log includes a merged data record 300 including a user account identifier 310, a request 320, a host header 330, a date 340, an authorization string 350, a combination thereof, and the like. In some embodiments, a user account identifier 310 identifies the user of the account who is making the network request. In an embodiment, the user account identifier 310 includes a user account identification name and a domain name. In certain embodiments, a request 320 includes an operational function, a full key name of an object, a combination thereof, and the like. In some embodiments, the host header 330 includes a bucket name, a region code, a host site, a combination thereof, and the like. In an embodiment, the date 340 of the merged data record includes a month, year, date, weekday, a timestamp a combination thereof, and the like. The date 340 including a timestamp indicates the time the event was initiated by the account user, in various embodiments. The timestamp of the request includes the hour, the minutes, the seconds, the time zone, a combination thereof, and the like, in some embodiments.

In certain embodiments, the data log aggregator (FIG. 1, 120) is configured to generate a merged record for detected data logs with common data record values. In an embodiment, the data log aggregator (FIG. 1, 120) is configured to generate an aggregated data log based on the merged records that include the common data record values.

For example, in an embodiment, an array of dates 340 include dates that have been aggregated from a plurality of flow logs. For example, in an embodiment, the date ‘6 May 2023’ is associated with a first record, date ‘5 Jul. 2023’ is associated with a second record, etc. In some embodiments, an aggregated array (e.g., an array into which multiple data values are stored) is a fixed size, an unfixed size, etc. In certain embodiments, the array size is fixed based on a number of bytes, a number of values, a number of characters, a combination thereof, and the like.

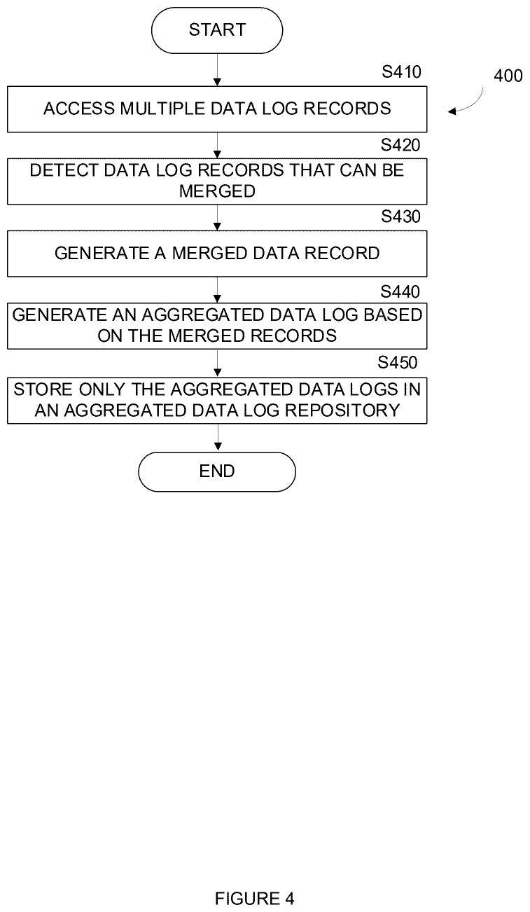

FIG. 4 is an example flowchart 400 of a method for generating and storing an aggregated data flow log, implemented in accordance with an embodiment.

At S410, multiple data log records are accessed. In an embodiment, data log records are generated by a serverless function (e.g., of FIG. 1, 116). In an embodiment, the function is configured to generate data logs based on data from events, messages, requests, detected event history within a specified time frame, a combination thereof, and the like.

In some embodiments, the log is generated based on data, events, messages, and the like, from network interfaces in a VPC. In an embodiment, a data log aggregator is configured to access the data log records in a log repository. For example, in an embodiment, an aggregator is provided with credentials to access a repository, such as a bucket, Cloudtrail, etc., where log records are stored.

At S420, mergeable data log records are detected. In various embodiments, the data log aggregator is configured to detect data log records in the log repository. In some embodiments, the aggregator is configured to utilize a heuristic, a data matching pattern technique, and the like, to detect data record values of a first data log record correspond to data record values from a second data log record.

In an embodiment, where a match of data record values is detected between multiple data log records in the log repository, a merged data record is generated. For example, in an embodiment, the data log aggregator is configured to detect data log records that are merged based on matching data record values of any one of: a user account identifier, a host header, a combination thereof, and the like.

According to an embodiment, a first value of a data field of a first record matches a second value of the data field of a second record in response to detecting a full match between the values, a partial match between the values, etc. For example, in an embodiment, a heuristic specifies that a first value of a host header matches a second value of the host header where the first three fields of the host header matches. In such an embodiment, a host header having a bucket name of “bucket.s6” will match a record having a bucket name of “bucket.s6”.

At S430, a merged data record is generated. In an embodiment a merged data record is generated by a data log aggregator in response to detecting a common data record value. In some embodiments, a common data record value is a corresponding data record value between a first data log record and a second data log record. For example, in an embodiment where a first data log record and a second data log record both have a user account identifier of ‘user6@account.com’, then the common data record value is ‘user6@account.com’.

At S440, an aggregated data log is generated based on the merged records. In an embodiment, a merged record includes common data record values of detected data logs from the log repository. The data log aggregator is configured to generate an aggregated data log based on a plurality of merged records, such that each merged record aggregates the common data values of multiple detected data log records.

In an embodiment, an aggregated data log includes a data record having a user account identifier, a request, a host header, an array of dates, an authorization string, a combination thereof, and the like. In certain embodiments, the aggregated data log includes a plurality of merged data records, and a data record which is not a merged data record.

At S450, the aggregated data log is stored in a repository. In an embodiment, only an aggregated data log is stored in a database, data lake, data warehouse, and the like. In some embodiments, the database is a cloud database which is a database that runs on a public or hybrid cloud computing platform. Cloud databases are hosted on servers maintained by cloud service providers such as AWS, Microsoft® Azure, Google Cloud Platform®, and the like. Cloud databases are managed by database-as-a-service (DBaaS) or deployed in a cloud-based virtual machine (VM). In other embodiments, the database utilizes a Snowflake® platform, and the like platforms which are designed for cloud environments and leverage the storage and computing power of cloud infrastructure and further utilizes a unique SQL query engine.

In an embodiment, the aggregated data log includes only aggregated records (e.g., merged records). In some embodiments, certain records are filtered from the data log. For example, in certain embodiments, a record including a value of a date field, which is a predetermined value, is excluded from being a merged record. In an embodiment, a record having an “ERROR” indicator, for example, is excluded from the merging process.

In some embodiments, certain data records are filtered based on predetermined rules, and such data records are not utilized to generate merged data records, and further are not stored in the aggregated log.

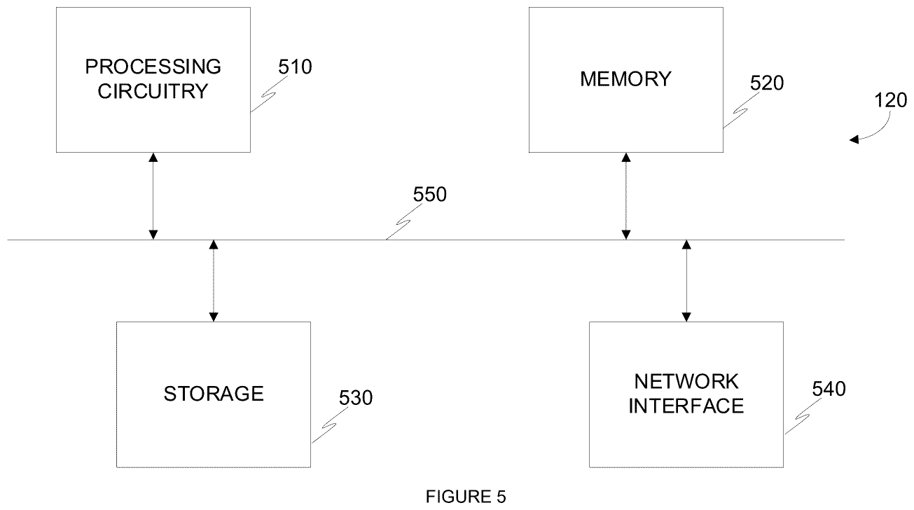

FIG. 5 is an example schematic diagram of a data log aggregator (FIG. 1, 120) according to an embodiment. The data log aggregator 120 includes, according to an embodiment, a processing circuitry 510 coupled to a memory 520, a storage 530, and a network interface 540. In an embodiment, the components of the data log aggregator 120 are communicatively connected via a bus 550.

In certain embodiments, the processing circuitry 510 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 520 is a volatile memory (e.g., random access memory, etc.), a non-volatile memory (e.g., read only memory, flash memory, etc.), a combination thereof, and the like. In some embodiments, the memory 520 is an on-chip memory, an off-chip memory, a combination thereof, and the like. In certain embodiments, the memory 520 is a scratch-pad memory for the processing circuitry 510.

In one configuration, software for implementing one or more embodiments disclosed herein is stored in the storage 530, in the memory 520, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 510, cause the processing circuitry 510 to perform the various processes described herein, in accordance with an embodiment.

In some embodiments, the storage 530 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 540 is configured to provide the data log aggregator 120 with communication with, for example, the log 118, according to an embodiment.

It should be understood that the embodiments described herein are not limited to the specific architecture illustrated in FIG. 5, and other architectures may be equally used without departing from the scope of the disclosed embodiments.

Furthermore, in certain embodiments the data log aggregator 120, the database 130, the log 118, the function 116, the resource 112, the storage 114, a combination thereof, and the like, may be implemented with the architecture illustrated in FIG. 5. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for generating and storing an aggregated data log comprising:
accessing a plurality of data log records in a data log repository;
detecting a plurality of data log records in the data log repository, wherein each data log record includes a plurality of data fields;
detecting a first data log record of the plurality of data log records having a first data field value in common with a second data log record;
detecting in the first data log record a second data field having a second value;
detecting in the second data log record the second data field having a third value;
generating a merged data record including: the first data field value, the second value and the third value;
generating an aggregated data log based on the merged data record, wherein the aggregated data log includes a plurality of merged data records; and
storing the aggregated data log in an aggregated data log repository.

2. The method of claim 1, further comprising:
matching a data record value of the first data log record to a corresponding data record value of another data log record to detect a common data field value.

3. The method of claim 1, further comprising:
generating a merged data record in response to detecting at least one common data record value between a plurality of data log records from the data log repository.

4. The method of claim 1, further comprising:
generating an aggregated data log that includes common data record values from the merged data records.

5. The method of claim 1, wherein the first data field includes any one of: an account identifier, a host header, a date, an authorization string, and any combination thereof.

6. The method of claim 1, further comprising:
detecting a data log record that is based on any one of: a data record, an event, a message, a request, an action in a virtual private cloud environment, and any combination thereof.

7. The method of claim 1, further comprising:
generating the aggregated data log based on a plurality of merged data records, wherein a first merged data record is generated from a first data log and a second merged data record is generated from a second data log.

8. The method of claim 1, further comprising:
determining that a first data field value is common in response to detecting at least a partial match between a value of the first data log record and a value of the second data log record.

9. The method of claim 1, further comprising:
filtering out a portion of records of the plurality of data records based on a value of a data field; and
generating the aggregated data log based on the merged data record without the filtered portion of records.

10. A non-transitory computer-readable medium storing a set of instructions for generating and storing an aggregated data log, the set of instructions comprising:
one or more instructions that, when executed by one or more processors of a device, cause the device to:
access a plurality of data log records in a data log repository;
detect a plurality of data log records in the data log repository, wherein each data log record includes a plurality of data fields;
detect a first data log record of the plurality of data log records having a first data field value in common with a second data log record;
detect in the first data log record a second data field having a second value;
detect in the second data log record the second data field having a third value;
generate a merged data record including: the first data field value, the second value and the third value;
generate an aggregated data log based on the merged data record, wherein the aggregated data log includes a plurality of merged data records; and
store the aggregated data log in an aggregated data log repository.

11. A system for generating and storing an aggregated data log comprising:
one or more processing circuitries configured to:
access a plurality of data log records in a data log repository;
detect a plurality of data log records in the data log repository, wherein each data log record includes a plurality of data fields;
detect a first data log record of the plurality of data log records having a first data field value in common with a second data log record;
detect in the first data log record a second data field having a second value;
detect in the second data log record the second data field having a third value;
generate a merged data record including: the first data field value, the second value and the third value;
generate an aggregated data log based on the merged data record, wherein the aggregated data log includes a plurality of merged records; and
store the aggregated data log in an aggregated data log repository.

12. The system of claim 11, wherein the one or more processing circuitries are further configured to:
match a data record value of the first data log record to a corresponding data record value of another data log record to detect a common data field value.

13. The system of claim 11, wherein the one or more processing circuitries are further configured to:
generate a merged data record in response to detecting at least one common data record value between a plurality of data log records from the data log repository.

14. The system of claim 11, wherein the one or more processing circuitries are further configured to:
generate an aggregated data log that includes common data record values from the merged data records.

15. The system of claim 11, wherein the first data field includes any one of:
an account identifier, a host header, a date, an authorization string, and any combination thereof.

16. The system of claim 11, wherein the one or more processing circuitries are further configured to:
detect a data log record that is based on any one of:
a data record, an event, a message, a request, an action in a virtual private cloud environment, and any combination thereof.

17. The system of claim 11, wherein the one or more processing circuitries are further configured to:
generate the aggregated data log based on a plurality of merged data records, wherein a first merged data record is generated from a first data log and a second merged data record is generated from a second data log.

18. The system of claim 11, wherein the one or more processing circuitries are further configured to:
determine that a first data field value is common in response to detecting at least a partial match between a value of the first data log record and a value of the second data log record.

19. The system of claim 11, wherein the one or more processing circuitries are further configured to:
filter out a portion of records of the plurality of data records based on a value of a data field; and
generate the aggregated data log based on the merged data record without the filtered portion of records.
